(19) United States
(12) Patent Application Publication
(10) Pub. No.: US 2020/0376441 A1
(43) Pub. Date: Dec. 3, 2020

(54) SULFONATED AND HALIDE MEMBRANES OR SOLID MATERIALS WITH THERMO-RESPONSIVE SURFACE TREATMENT

(71) Applicant: Membio Inc., Kitchener (CA)

(72) Inventor: Moin Ahmed, Kitchener (CA)

(21) Appl. No.: 16/889,938

(22) Filed: Jun. 2, 2020

Related U.S. Application Data
(60) Provisional application No. 62/856,315, filed on Jun. 3, 2019.

(30) Foreign Application Priority Data
Sep. 30, 2019 (CA) PCT/CA2019/051397

(51) Int. Cl. B01D 67/00; B01D 69/12; B01D 71/36; B01D 71/34; B01D 71/68; B01D 71/56; B01D 61/14

(52) U.S. Cl. CPC B01D 67/0093; B01D 69/125; B01D 71/36; B01D 71/34; B01D 71/68; B01D 2323/38; B01D 61/145; B01D 61/147; B01D 2323/30; B01D 2323/36; B01D 71/56

(57) ABSTRACT

This specification describes methods of functionalizing the surface of a solid polymer, for example with an anti-fouling or thermo-responsive compound such as PNIPAAm. The polymer may inherently comprise a halide, as in for example polyvinylidene fluoride (PVDF) or polytetrafluoroethylene (PTFE). Alternatively, the polymer may be surface treated to include a halide. In some examples, polysulfone (PS) or polyethersulfone (PES) are surface initiated to comprise a halide by lithiation or acylation. The halide-containing polymer is then functionalized, for example with PNIPAAm by way of atom transfer radical polymerization (ATRP), which may be activator regenerated by electron transfer (ARGET) ATRP. The polymer may be in the form of a membrane, for example a microfiltration or ultrafiltration membrane containing the polymer alone or blended with one or more other polymers. In some examples membranes comprising PS, PES, PVDF or PTFE functionalized with PNIPAAm.

### RELATED APPLICATIONS

This application claims the benefit of U.S. provisional application No. 62/856,315 filed on Jun. 3, 2019, which is incorporated herein by reference. This application also claims priority from International Application Number PCT/CA2019/051397 filed on Sep. 30, 2019, which is incorporated herein by reference.

### FIELD

This specification relates to a surface treatment of a solid made with sulfonated and halide polymers, for example a membranes or cell culture container, such that the solid is functionalized with a stimulus responsive, i.e. a thermo-responsive, or anti-fouling compound such as poly(N-isopropylacrylamide), and to cell culture using such a composition.

### BACKGROUND

M. Zhuang et al., in Thermo-responsive poly(N-isopropylacrylamide)-grafted hollow fiber membranes for osteoblasts culture and non-invasive harvest, Materials Science and Engineering C55 (2015) 410-419, describe hollow fiber membranes functionalized with poly(N-isopropylacrylamide) (PNIPAAm). The membranes are made of cellulose acetate. The PNIPAAm is grafted onto the membranes via free radical polymerization in the presence of Cerium (IV) nitrate.

### INTRODUCTION

The following introduction is intended to introduce the reader to the detailed description to follow and not to limit or define any claimed invention.

This specification describes methods of functionalizing the surface of a solid comprising a halide or sulfonated polymer. In some examples, the functionalizing is to attach a stimulus responsive, i.e. thermo-responsive, or anti-fouling compound such as PNIPAAm, alone or in a co-polymer including PNIPAAm. The halide polymer may be, for example, polyvinylidene fluoride (PVDF) or polytetrafluoroethylene (PTFE). The sulfonated polymer may be, for example, polysulfone (PS) or polyethersulfone (PES). A sulfonated polymer is treated, for example by surface modification, to comprise a halide, for example in the form of an available C—X bond wherein X is a halide. The surface modification may involve lithiation or acylation. A halide-containing polymer (whether a halide polymer or a surface modified sulfonated polymer) is attached at the surface of the object to a functionalizing compound, for example PNIPAAm or a co-polymer including PNIPAAm. The surface attachment may be by way of atom transfer radical polymerization (ATRP), which may be activator regenerated by electron transfer (ARGET) ATRP. The solid may be in the form of a microporous membrane, for example a previously formed microfiltration or ultrafiltration membrane, comprising the halide or sulfonated polymer alone or blended with one or more other compounds. In other examples, the solid is non-porous, for example a cell culture container such as a well plate, chamber, flask or disk.

This specification also describes functionalized solids such as membranes and cell culture consumables produced by the methods described above. For example, this specification describes membranes or cell culture container comprising one or more of PS, PES, PVDF or PTFE functionalized with PNIPAAm. In some examples, the functionalized solids may be sterilized, once or repeatedly, by gamma radiation or by treatment in an autoclave.

This specification also describes a cell culture process in which cells, for example adherent or anchorage dependent cells, are grown on a functionalized solid as described herein at a first temperature. The temperature is changed, for example reduced, to a second temperature to assist with removing the cells from the functionalized solid. The cells may be grown as individual cells or as aggregates of cells such as a tissue. Optionally, the solid may be a membrane used to supply one or more nutrients to the cells, for example by way of perfusion or gas transfer.

### BRIEF DESCRIPTION OF THE FIGURES

FIG. 1 is a schematic drawing of Friedel-Crafts acylation of a PS or PES membrane.

FIG. 2 is a schematic drawing of lithiation of a PS or PES membrane.

FIG. 3 is a schematic drawing of a halide-containing membrane functionalized with PNIPAAm by way of ATRP.

FIG. 4 is a schematic drawing of a halide-containing membrane functionalized with PNIPAAm by way of ARGET-ATRP.

FIG. 5 is an FTIR plot of PES samples surface initiated by Friedel-Crafts acylation and lithiation.

FIG. 6 is an FTIR plot of PES functionalized with PNIPAAm.

FIG. 7 is an FTIR plot of PS functionalized with PNIPAAm.

FIGS. 8 to 11 are graphs of contact angle measurements for PES membranes functionalized with PNIPAAm.

FIG. 12 is an FTIR plot of PVDF functionalized with PNIPAAm.

FIG. 13 is an FTIR plot of PTFE functionalized with PNIPAAm.

FIG. 14 shows the contact angles of: PES at 25° C. (upper left panel); PES at 60° C. (lower left panel); PES-PNIPAAm at 25° C. (upper right panel); and, PES-PNIPAAm at 60° C. (lower right panel).

### DETAILED DESCRIPTION

Methods of functionalizing a sulfonated or halide-containing polymer are described below. In some examples, the polymer is functionalized on its surface with an anti-fouling or thermo-responsive compound. For example, the surface may have a PNIPAAm polymer brush attached to it. The PNIPAAm brush is thermally responsive. In particular, PNIPAAm is more hydrophobic with a more coiled structure at temperatures over the LCST of about 32° C. and less hydrophobic with a straighter structure at lower temperatures. The functionalized surface can be used to support the growth of anchorage dependent cells. The cells are harvested by increasing or decreasing temperature to change the surface depending on the cells used.

The functionalization method uses a halide on the surface of the polymer. The halide may be part of an available C—X bond, wherein X is a halide. The polymer may inherently comprise the halide, as in for example polyvinylidene fluoride (PVDF) or polytetrafluoroethylene (PTFE). Alternatively, the polymer may be treated to include the halide. In some examples, sulfonated polymers such as polysulfone (PS) or polyethersulfone (PES) may be treated, for example by surface modification, to comprise a halide. The surface modification may involve lithiation or acylation.

The halide-containing polymer may be functionalized with PNIPAAm by way of atom transfer radical polymerization (ATRP), which may be activator regenerated by electron transfer (ARGET) ATRP. The polymer may be in the form of a membrane, for example a microfiltration or ultrafiltration membrane. The membrane may be, for example, a hollow fiber membrane, a flat sheet membrane coated on a textile substrate, a tubular membrane, a filter paper or an electrospun, melt spun or non-woven sheet. The membrane may be part of a cell culture bioreactor, for examples as described in International Publication Number WO 2020/069607, Cell Culture Bioreactor, which is incorporated herein by reference. In other examples, the polymer may be part of a non-porous cell culture container such as a flask, chamber, dish or well plate. The halide-containing polymer may be used alone or blended with one or more other polymers in the membrane. Products of the processes described herein include membranes or cell culture containers comprising one or more of PS, PES, PVDF or PTFE functionalized with PNIPAAm.

As mentioned above, in order to use the functionalization described herein, sulfonated membranes such as PS and PES are first surface initiated. In the surface initiation, a compound is attached, for example covalently attached, to the surface of the membrane. In some examples, the attachment is by a lithiation reaction, for example using butyllithium. In other examples, the attachment is by Friedel-Crafts acylation. In either case an initiator, which may be an acyl chloride (i.e. a compound containing an acyl chloride group), is attached to the membrane or other surface. The acyl chloride has a C—X group, wherein X is a halide, preferably in addition to the acyl chloride group. The acyl chloride group attaches to the membrane or other surface leaving the C—X group available at the surface for the functionalization reaction. The acyl chloride may be, for example, pentadecafluoroocatyl chloride or (3-methyl) benzoyl chloride.

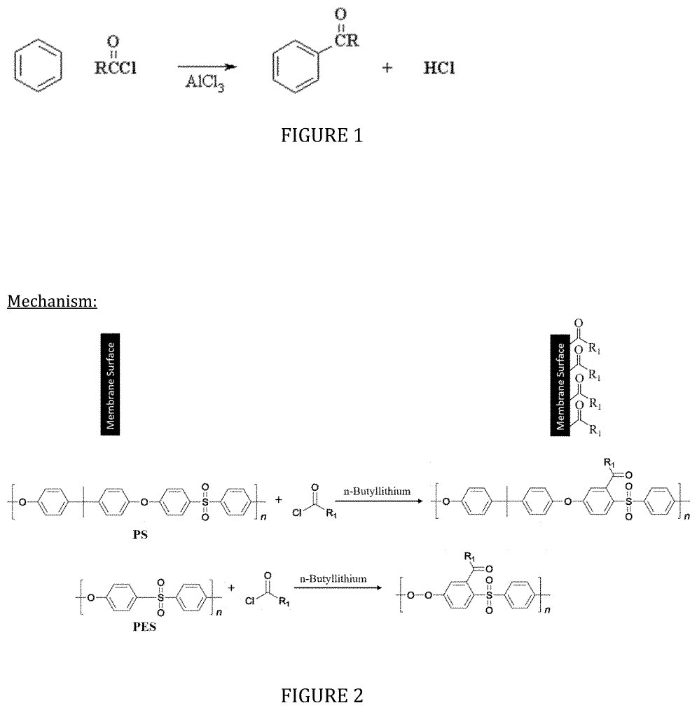

FIG. 1 shows a mechanism for Friedel-Craft acylation of PS or PES. FIG. 2 shows a mechanism for lithiation of PS or PES. As an intermediate product, PS and PES membranes are produced with a C—X moiety, wherein X is a halide.

Although chloroform is commonly used as a solvent in Friedel-Crafts acylation, it dissolved the PS and PES membranes in a trial. Other Friedel-Crafts compatible solvents such as dichloromethane, chloromethane, nitrobenzene and chlorobenzene were also tried but dissolved or disintegrated PS and PES membranes. Ethanol (with an FeCl₃ catalyst) and acetonitrile were tried and did not dissolve the PS and PES membranes but were not compatible with the Friedel-Crafts acylation reaction. However, hexane was found to not dissolve or disintegrate the membrane and to be compatible with the Friedel-Crafts reaction. Alternatively, alkanes may be used.

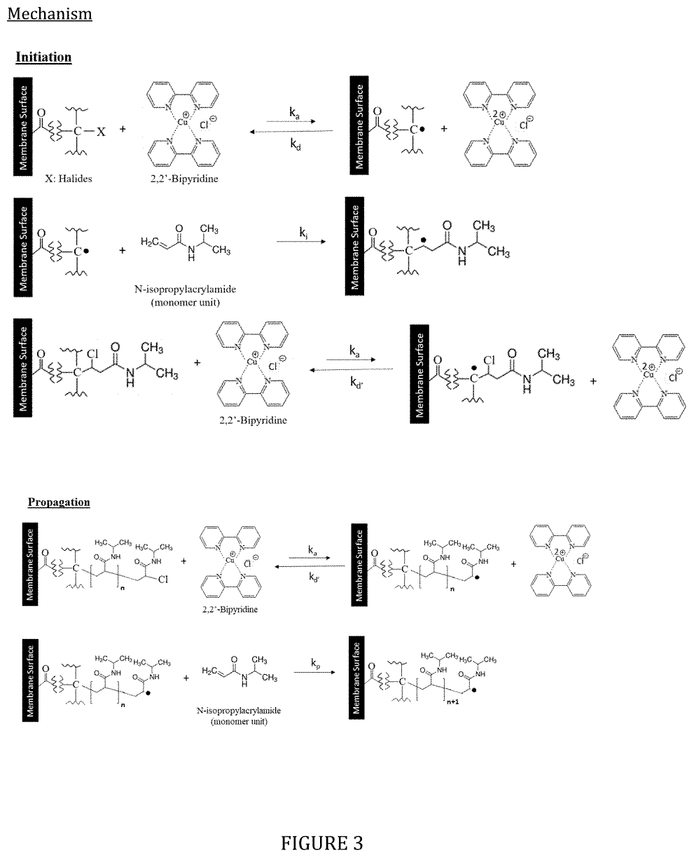

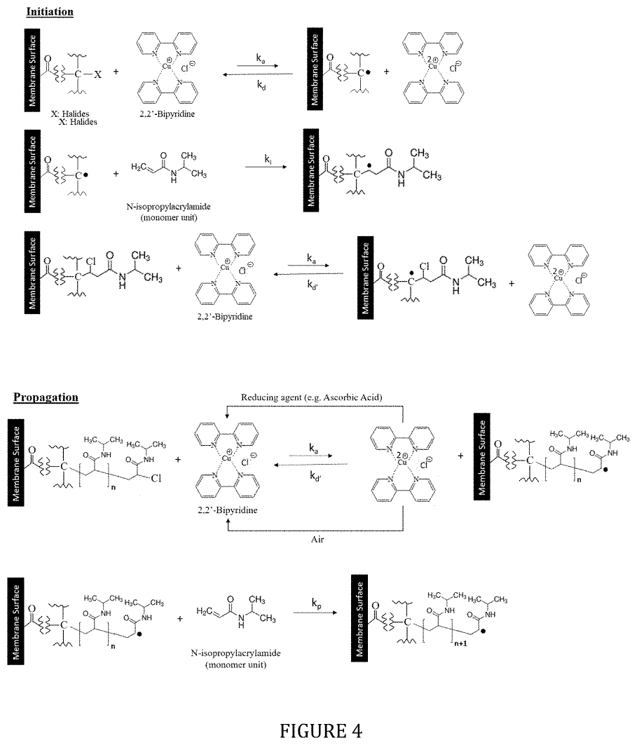

In some examples, the membrane is functionalized by attaching N-isopropyl acrylamide to the surface in place of the halide. Optionally, the N-isopropyl acrylamide can then be polymerized according to an ATRP (as shown in FIG. 3) or ARGET-ATRP reaction (as shown in FIG. 4) to produce PNIPAAm.

### Examples

Procedure for Surface Initiation of PS or PES Membranes by Friedel-Crafts Acylation

1. Soak membrane in ethanol for at least 2 hours, then soak in hexane or an alkane for 0.5 hours.
2. Add hexane or alkane and wet membrane to flask.
3. Add condenser and drying tube and cool the reaction mixture in an ice bath.
4. Add AlCl₃ slowly in the reaction mixture as the reaction between aluminum chloride and acyl chloride is very exothermic.
5. After addition is complete, remove the ice bath and allow the temperature to come to room temperature
6. After the solution is at room temperature, allow the reaction to continue for at least 15 minutes
7. Remove and wash the membrane.

Procedure for Surface Initiation of PS or PES Membranes by Lithiation

1. Dry up a round 3-neck bottom flask (RBF), syringe needle and stir bar.
2. Connect the RBF to a condenser (with flowing cold water) and N₂ line. Cap the third neck of the RBF with a rubber septum.
3. Purge/bubble the solvent (i.e. approx. 60 ml of diethyl ether) with dry nitrogen for 5 min and add the solvent into the RBF using a syringe (needle is pierced into the rubber septum of the capped neck of RBF to add the solvent).
4. Add butyl lithium dropwise using the dried syringe (needle is pierced into the rubber septum of the capped neck of RBF to add the butyl lithium).
5. Leave the solution to stir for 2 hours in a cool water bath (approx. 17 ml) under nitrogen environment.
6. After 2 hours of stirring, add the initiator (example pentadecafluoroocatyl chloride or (3-methyl) benzoyl chloride) into the solution.
7. Leave the solution to stir for 1 hour.
8. After 1 hour of stirring, quench the reaction by adding ethanol. Leave the ethanol to stir for 30 minutes.
9. Take the membranes out of the solution and wash them thoroughly with ethanol and deionized water. Dispose of the solution appropriately.

Procedure for ATRP Functionalization of Halide Containing Membrane

1. Dry Schlenk flask and stir bar.
2. Connect Schlenk flask to nitrogen inlet line.
3. Add appropriate amounts of copper (I) chloride, 2,2′-Bipyrindine and N-isopropyl acrylamide monomer.
4. Purge/bubble the solvent (50 v %:50 v % ethanol:deionized water) with dry nitrogen for 5 min.
5. Connect the neck of Schlenk flask to condenser (with flowing cold water).
6. Leave the solution to stir for 3 hours in a water bath (35° C.).
7. After 3 hours of stirring, take the membranes out of the solution. Wash the membranes thoroughly with deionized water. Dispose of the solution appropriately.

Procedure for ARGET-ATRP Functionalization of Halide Containing Membrane

1. Dry Schlenk flask and stir bar.
2. Connect Schlenk flask to nitrogen inlet line.
3. Add appropriate amounts of copper (II) chloride, ascorbic acid, 2,2′-Bipyrindine and N-isopropyl acrylamide monomer.
4. Purge/bubble the solvent (50 v %:50 v % ethanol:deionized water) with dry nitrogen for 5 min.
5. Connect the neck of Schlenk flask to condenser (with flowing cold water).
6. Leave the solution to stir for 3 hours in a water bath (35° C.).
7. After 3 hours of stirring, take the membranes out of the solution. Wash the membranes thoroughly with deionized water. Dispose of the solution appropriately.

Surface Functionalization of PES and PS Membranes

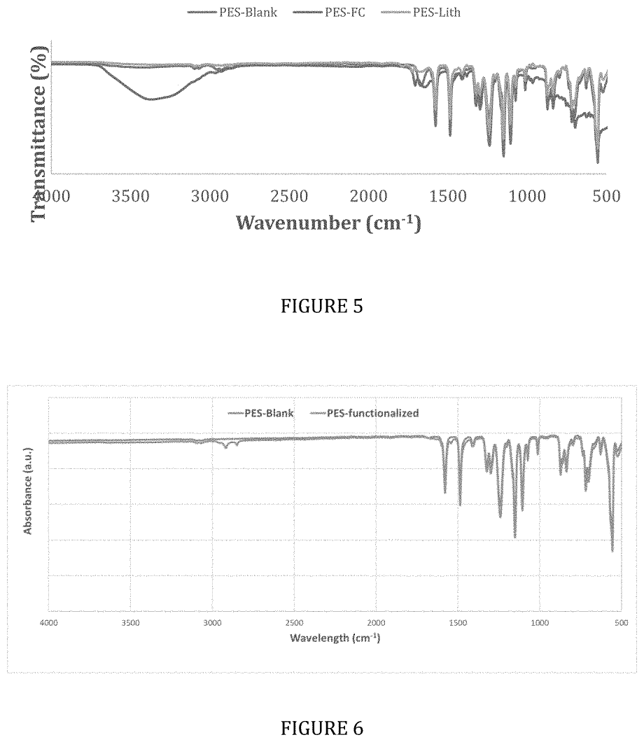

Samples of PES and PS microfiltration filter papers where surface initiated using Friedel-Crafts acylation and lithiation as described above. FIG. 5 shows FTIR plots of two samples after surface initiation, one sample treated by each of the two methods. Both samples exhibit a C═O stretch indicating that the surface initiation was successful. In these examples, the Friedel-Crafts acylation produces stronger surface initiation, but it is unknown whether that result is typical or only present in this particular example.

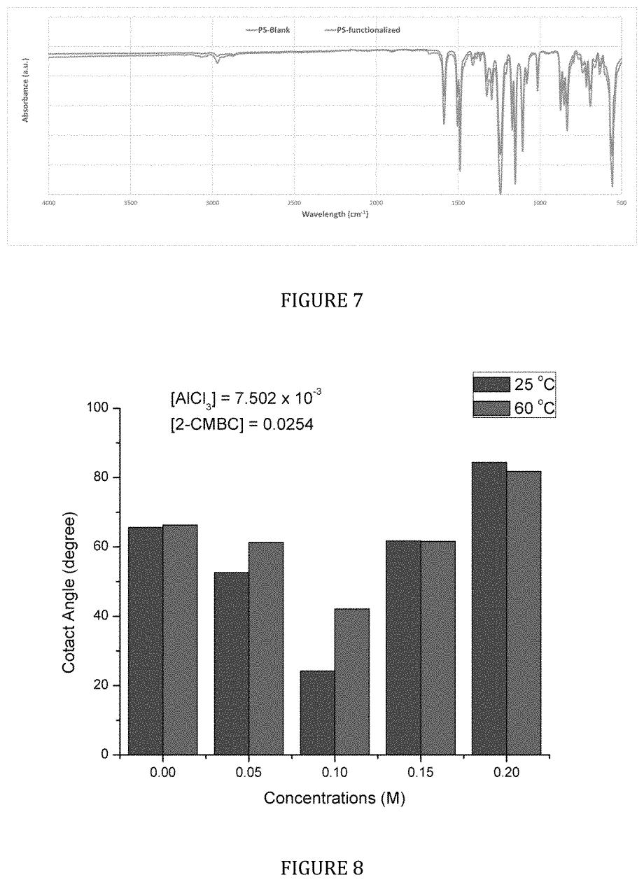

Samples of PES and PS microfiltration filter papers surface initiated by Friedel-Crafts acylation using Pentadecafluorooctanyl chloride (PDFOC) or (3-methyl) benzoyl chloride (CM BC) as the initiator were then functionalized with poly(N-isopropylacrylamide) (PNIPAAm) using an ATRP mechanism as shown in FIG. 3. FIGS. 6 and 7 show FTIR of the treated membranes. As indicated in the figures, peaks were created or strengthened at 1550 cm⁻¹ and 1630⁻¹ in both samples indicating that PNIPAAm had been attached to the surface of both membranes.

Samples of PES and PS hollow fiber membranes were surface initiated by lithiation using 4.5 mmol butyl lithium using PDFOC or CMBC and then functionalized with poly(N-isopropylacrylamide) (PNIPAAm) using an ATRP mechanism as shown in FIG. 3. The starting concentration of PNIPAAm for the ATRP reactions was from 50 mmol and 100 mmol in two trials using PES membranes and 50 mmol and 200 mmol in two trials using PS membranes. Attachment of the PNIPAAm was confirmed by FTIR for all samples but peaks indicative of PNIPAAm were stronger for the samples with higher starting concentration of PNIPAAm.

Samples of PES hollow fiber membranes were surface initiated by Friedel-Crafts acylation using PDFOC or 3-methyl benzoyl chloride CMBC at three different concentrations and then functionalized with poly(N-isopropylacrylamide) (PNIPAAm) using an ATRP mechanism as shown in FIG. 3. The starting concentration of PNIPAAm for the ATRP reactions ranged from 0.05 to 0.2 M.

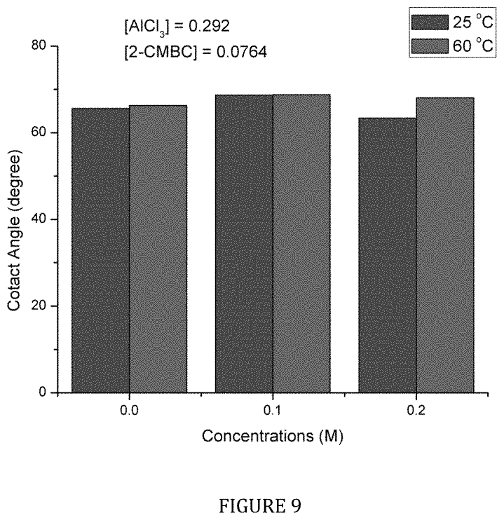

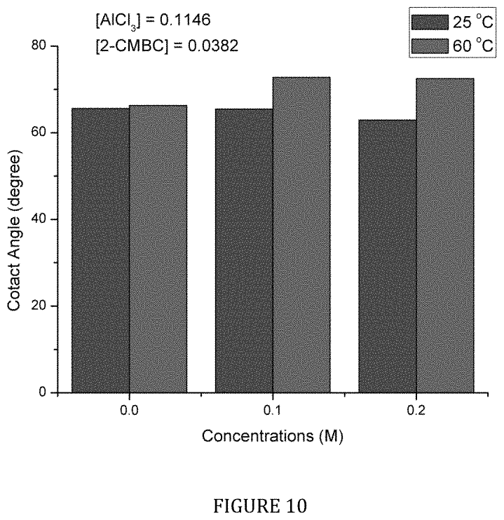

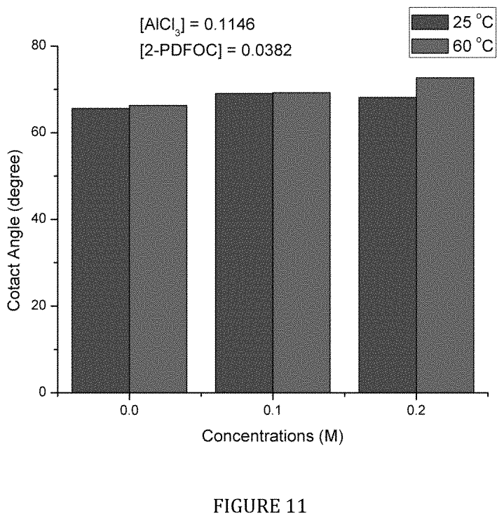

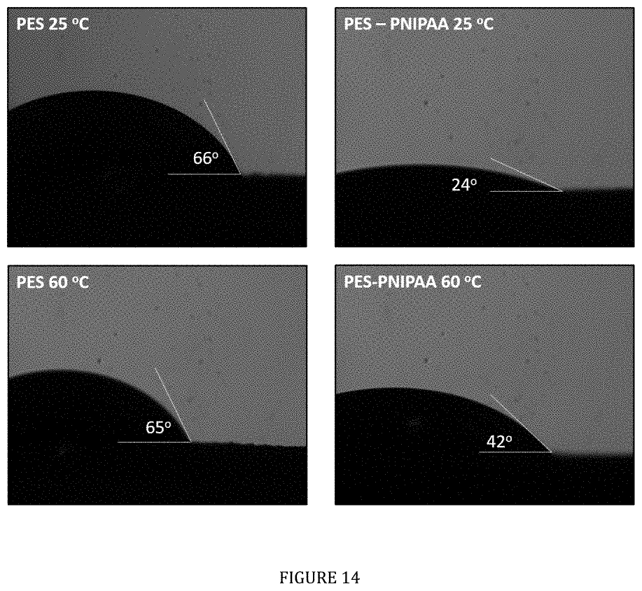

Contact angle measurements were taken at 25° C. and 60° C. to determine the thermal responsiveness of the functionalized membranes. The results are given in FIGS. 8, 9, 10, 11 and 14. Thermal responsiveness is indicated by a change in contact angle with temperature. The number of reaction sites available on the surface is expected to correspond with the concentrations used in the Friedel-Crafts acylation reaction and the compounds used. PDFOC has more C—X groups and is expected to produce more surface sites in a Friedel-Crafts acylation than CMBC at the same concentration. The results in FIGS. 8-11 suggest that thermal responsiveness is related to both the surface initiation reaction and the monomer concentration in the ATRP reaction.

Surface Functionalization of PVDF and PTFE Membranes

Samples of PVDF and PTFE ultrafiltration hollow fiber membranes where functionalized with poly(N-isopropylacrylamide) (PNIPAAm) using an ATRP mechanism as shown in FIG. 3. The procedure used was as follows:

1. Dry flask and stir bar.
2. Connect flask to nitrogen inlet line.
3. Add copper (I) chloride, 2,2′-Bipyrindine and N-isopropyl acrylamide monomer.
4. Purge/bubble the solvent (50 v %:50 v % ethanol:deionized water) with dry nitrogen for 5 min.
5. Connect the neck of flask to condenser (with flowing cold water).
6. Leave the solution to stir for 3 hours in a water bath (35° C.).
7. After 3 hours of stirring, take the membranes out of the solution. Wash the membranes thoroughly with deionized water. Dispose of the solution appropriately.

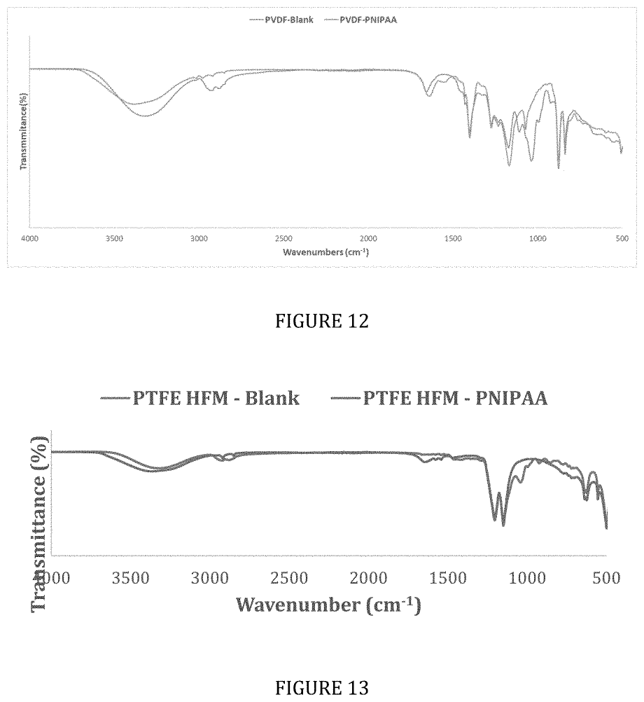

FIGS. 12 and 13 show FTIR of the treated membranes. As indicated in the figures, peaks were created or strengthened at 1550 cm⁻¹ and 1630⁻¹ in both samples indicating that PNIPAAm had been attached to the surface of both membranes.

Vero Cell Shedding from Polyethersulfone (PES) Membranes

Polyethersulfone (PES) membranes were functionalized with PNIPAAm by way of surface initiation by directed ortho metalation (lithiation) followed by atom transfer radical polymerization (ATRP) as described herein.

In this example, to perform the lithiation, 70 mg of PES membranes are soaked in ethanol for 2 hours. 60 mL of diethyl ether is placed into a Schlenk flask and purged with nitrogen for 15 min. The membranes are added to the Schlenk flask and purged with nitrogen for 15 min. 0.237 ml of butyllithium (Bu-Li) is added under inert atmosphere with capped condenser. The reaction is stirred for 2 hours in a water bath of around 17° C. 0.88 ml of 3-(chloromethyl)benzoyl chloride is added stirred for 1 hour. The reaction is quenched with 40 ml of ethanol. The membranes are removed, washed thoroughly and dried in air.

To functionalize the membranes, 25.38 mg Cu(1)Cl, 82.859 mg 2,2′-Bipyridyl, and 0.604 g NIPAA are added in a dry Schlenk flask. 30 ml of ethanol solution in DI water (50:50 v/v) is added. The surface initiated membranes are added into the Schlenk flask. The flask is purged with nitrogen for 15 min. A capped condenser is added and the reaction is stirred for 3 hours. The membranes are removed, washed thoroughly, and dried in air.

The contact angle of the untreated PES membrane has measured and was about 65° at both 25° C. and 60° C. The contact angle of the PES-PNIPAAm membrane made as described above was 24° at 25° C. and 42° at 60° C. Table 1 gives the flux of the membrane in DI water before and after functionalization.

TABLE 1

| | Flux (ml h⁻¹ m⁻²) | Flux (ml h⁻¹ m⁻²) |
|---|---|---|
| Membrane | at 25° C. | at 40° C. |
| PES | 31400 | 32154 |
| PES-PNIPAAm | 14200 | 5846 |

Samples of PES (without PNIPAAm) and PES-PNIPAAm (made as described above) were sterilized in an autoclave and cut into pieces of equal size. The cut samples were placed in some of the wells of a 96-well plate (there were less than 96 samples). 20,000 Vero cells were added in each well containing a membrane sample, along with a cell culture media of DMEm/F12+10% FBS2. After 24 hours of cell growing time, the plate was placed in a refrigerator at 4° C. for 10 hours. A first cell count of the media was performed to assess the number of cells shed from the membranes in the refrigerator. The wells were then trypsinized and a second cell count was performed to determine if cells remained on the membranes after refrigeration.

In one pair of samples, in the first cell count (before trypsinization) about 40,000 cells were counted from the well containing the PES-PNIPAAm sample and none were counted from the well containing PES sample. In the second cell count (after trypsinization) about 100,000 cells were counted from the well containing the PES sample and none were counted from a PES-PNIPAAm sample.

We claim:

1. A method of functionalizing a membrane comprising a sulfonated polymer comprising the steps of:
attaching an initiator compound to a surface of the membrane, wherein the initiator compound comprises a C—X group, wherein X is a halide; and,
attaching N-isopropyl acrylamide to the membrane in place of X, and polymerizing to form PNIPAAm.

2. The method of claim 1 wherein the initiator compound comprises an acyl chloride group.

3. The method of claim 2 wherein X is a halide in addition to the chlorine of the acyl chloride group.

4. The method of claim 3 wherein C is in addition to the acyl chloride group.

5. The method of claim 2 wherein the initiator compound is reacted to the membrane by lithiation or Friedel-Crafts acylation.

6. The method of claim 5 wherein the N-isopropyl acrylamide is polymerized by way of ATRP or ARGET-ATRP.

7. The method of claim 2 wherein the initiator compound is reacted to the membrane by Friedel-Crafts acylation.

8. The method of claim 7 wherein the solvent in Friedel-Crafts acylation is hexane or an alkane.

9. The method of claim 7 wherein the initiator is Pentadecafluorooctanyl chloride (PDFOC) or (3-methyl) benzoyl chloride (CMBC)

10. A method of functionalizing a halide-containing membrane comprising attaching N-isopropyl acrylamide to the membrane in place of the halide, and polymerizing to form PNIPAAm.

11. The method of any of claim 10 wherein the N-isopropyl acrylamide is polymerized by way of ATRP or ARGET-ATRP.

12. A composition comprising a solid containing one or more of PS, PES, PVDF or PTFE functionalized with PNIPAAm.

13. The composition of claim 12 wherein the solid is a microfiltration or ultrafiltration membrane.

14. The composition of claim 12 wherein the solid is a cell culture container.

15. The composition of claim 12 wherein the solid contains PS or PES.

16. The composition of claim 12 wherein the solid contains PVDF or PTFE.

17. The composition of claim 15 wherein the solid is a microfiltration or ultrafiltration membrane.

18. The composition of claim 16 wherein the solid is a microfiltration or ultrafiltration membrane.
